(19) United States
(12) Patent Application Publication
(10) Pub. No.: US 2026/0136340 A1
(43) Pub. Date: May 14, 2026

(54) METHODS FOR DETERMINING FREQUENCY-DOMAIN RESOURCE, AND APPARATUSES

(71) Applicant: Beijing Xiaomi Mobile Software Co., Ltd., Beijing (CN)

(72) Inventors: Xuemei QIAO, Beijing (CN); Qin MU, Beijing (CN); Jingyi WANG, Beijing (CN)

(73) Assignee: Beijing Xiaomi Mobile Software Co., Ltd., Beijing (CN)

(21) Appl. No.: 19/119,875

(22) PCT Filed: Oct. 14, 2022
(86) PCT No.: PCT/CN2022/125496

§ 371 Date: Apr. 10, 2025

(51) Int. Cl. H04W 72/0453; H04W 72/231; H04W 72/51; H04W 74/0833

(52) U.S. Cl. CPC H04W 72/0453; H04W 72/231; H04W 72/51; H04W 74/0833

(57) ABSTRACT

The present disclosure provides a method for determining a frequency domain resource, performed by an evolved reduced capability (eRedCap) terminal. The method includes: determining a mapping rule of virtual resource block (VRB)-to-physical resource block (PRB) supported by a physical downlink shared channel (PDSCH), wherein the mapping rule includes that interleaved mapping is not supported, or the mapping rule is a first interleaved mapping rule; and determining a physical frequency domain resource occupied by the PDSCH according to the mapping rule supported by the PDSCH and VRBs.

### CROSS REFERENCE TO RELATED APPLICATIONS

The present application is a U.S. national phase of International Application No. PCT/CN2022/125496, filed on Oct. 14, 2022, the disclosure of which is incorporated herein by reference in its entirety.

### TECHNICAL FIELD

The present disclosure relates to the field of communication technologies, and in particular to methods and apparatuses for determining a frequency domain resource.

### BACKGROUND

In Release 18, it is proposed that a bandwidth is further reduced for an evolved reduced capability (eRedCap) terminal device, for example, a baseband channel bandwidth of a physical downlink shared channel (PDSCH) of the eRedCap terminal device is reduced. Reducing the baseband channel bandwidth of the PDSCH of the eRedCap terminal device may result in a bandwidth of a bandwidth part (BWP) of the eRedCap terminal device exceeding the baseband bandwidth of the PDSCH. In this case, how to determine a physical frequency domain resource occupied by the PDSCH of the eRedCap terminal device becomes an urgent problem to be solved.

### SUMMARY

A first aspect of the present disclosure proposes a method for determining a frequency domain resource, which is performed by an evolved reduced capability (eRedCap) terminal device. The method includes: determining a mapping rule of virtual resource block (VRB)-to-physical resource block (PRB) supported by a physical downlink shared channel (PDSCH), where the mapping rule includes that interleaved mapping is not supported, or the mapping rule is a first interleaved mapping rule; and determining a physical frequency domain resource occupied by the PDSCH according to the mapping rule supported by the PDSCH and VRBs.

A second aspect of the present disclosure proposes a method for determining a frequency domain resource, which is performed by a network device. The method includes: determining a mapping rule of virtual resource block (VRB)-to-physical resource block (PRB) supported by a physical downlink shared channel (PDSCH) of an evolved reduced capability (eRedCap) terminal device, where the mapping rule includes that interleaved mapping is not supported, or the mapping rule is a first interleaved mapping rule; and allocating the frequency domain resource to the eRedCap terminal device according to the mapping rule of VRB-to-PRB supported by the PDSCH.

A third aspect of the present disclosure proposes a communication apparatus, including: one or more processors and a memory, where the memory is configured to store a computer program, and the one or more processors are configured to execute the computer program stored in the memory to cause the communication apparatus to perform the method in the embodiments of the first aspect.

A fourth aspect of the present disclosure proposes a communication apparatus, including: one or more processors and a memory, where the memory is configured to store a computer program, and the one or more processors are configured to execute the computer program stored in the memory to cause the communication apparatus to perform the method in the embodiments of the second aspect.

A fifth aspect of the present disclosure proposes a communication apparatus, including: one or more processors and an interface circuit; where the interface circuit is configured to receive code instructions and transmit the code instructions to the one or more processors; and the one or more processors are configured to run the code instructions to cause the apparatus to perform the method in the embodiments of the first aspect.

A sixth aspect of the present disclosure proposes a communication apparatus, including: one or more processors and an interface circuit; where the interface circuit is configured to receive code instructions and transmit the code instructions to the one or more processors; and the one or more processors are configured to run the code instructions to cause the apparatus to perform the method in the embodiments of the second aspect.

A seventh aspect of the present disclosure provides a communication system including the communication apparatus as described in the third aspect and the communication apparatus as described in the fourth aspect, or the system includes the communication apparatus as described in the fifth aspect and the communication apparatus as described in the sixth aspect.

An eighth aspect of the present disclosure proposes a computer-readable storage medium for storing instructions. When the instructions are executed, the method for determining the frequency domain resource described in the first aspect is implemented.

A ninth aspect of the present disclosure proposes a computer-readable storage medium for storing instructions. When the instructions are executed, the method for determining the frequency domain resource described in the second aspect is implemented.

Additional aspects and advantages of the present disclosure will be partially presented in the following description, some of which will become apparent from the following description, or learned through practice of the present disclosure.

### BRIEF DESCRIPTION OF THE DRAWINGS

In order to more clearly explain the technical solution in the embodiments of the present disclosure or the background, the accompanying drawings required in the embodiments of the present disclosure or the background will be described below.

FIG. 1 is a schematic architectural diagram of a communication system according to an embodiment of the present disclosure.

FIG. 2 is a flowchart of a method for determining a frequency domain resource according to an embodiment of the present disclosure.

FIG. 3 is a flowchart of a method for determining a frequency domain resource according to an embodiment of the present disclosure.

FIG. 4 is a flowchart of a method for determining a frequency domain resource according to an embodiment of the present disclosure.

FIG. 5 is a flowchart of a method for determining a frequency domain resource according to an embodiment of the present disclosure.

FIG. 6 is a flowchart of a method for determining a frequency domain resource according to an embodiment of the present disclosure.

FIG. 7 is a flowchart of a method for determining a frequency domain resource according to an embodiment of the present disclosure.

FIG. 8 is a schematic structural diagram of a communication apparatus according to an embodiment of the present disclosure.

FIG. 9 is a schematic structural diagram of a communication apparatus according to an embodiment of the present disclosure.

FIG. 10 is a schematic structural diagram of a chip according to an embodiment of the present disclosure.

### DETAILED DESCRIPTION OF THE EMBODIMENTS

For ease of understanding, terms involved in the present disclosure are first introduced.

### 1. Bundle Size

When mapping a virtual resource block (VRB) to a physical resource block (PRB), partitioning mapping is generally performed on a resource block (RB), and a bundle is a group of RBs after partitioning. The bundle size refers to a number of RBs included in a bundle, which is generally provided by a protocol or high-level signaling, generally 2 or 4. The bundle size can also be referred to as a size of the bundle.

### 2. Number of Bundles

The number of bundles refers to a number of bundles included in a bandwidth part (BWP).

### 3. Maximum Available Bandwidth Range of a Physical Downlink Shared Channel (PDSCH)

A maximum available bandwidth of the PDSCH is used to represent a maximum frequency domain bandwidth range that can be used for data transmission by an evolved reduced capability (eRedCap) terminal device, that is, a number of frequency domain resources that can be used. The maximum available bandwidth range refers to that during the transmission with the channel, the frequency domain resource that can be used includes which RBs. For example, for the eRedCap terminal device, if the maximum available bandwidth of the PDSCH is limited to 5 MHz, the maximum available bandwidth range of the PDSCH is used to represent which PRBs are included in the 5 MHz.

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the embodiments of the present disclosure as detailed in the appended claims.

Terms used in the embodiments of the present disclosure are for the purpose of describing specific embodiments only, and are not intended to limit the embodiments of the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, and the like may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

Hereinafter, the embodiments of the present disclosure will be described in detail, examples of which are illustrated in the accompanying drawings, where the same or similar reference signs indicate the same or similar elements throughout. The embodiments described below by referring to the accompanying drawings are exemplary and are intended to explain the present disclosure, and should not be construed as limiting the present disclosure.

In order to better understand methods for determining a frequency domain resource disclosed in the embodiments of the present disclosure, a communication system to which the embodiments of the present disclosure applies will be described below.

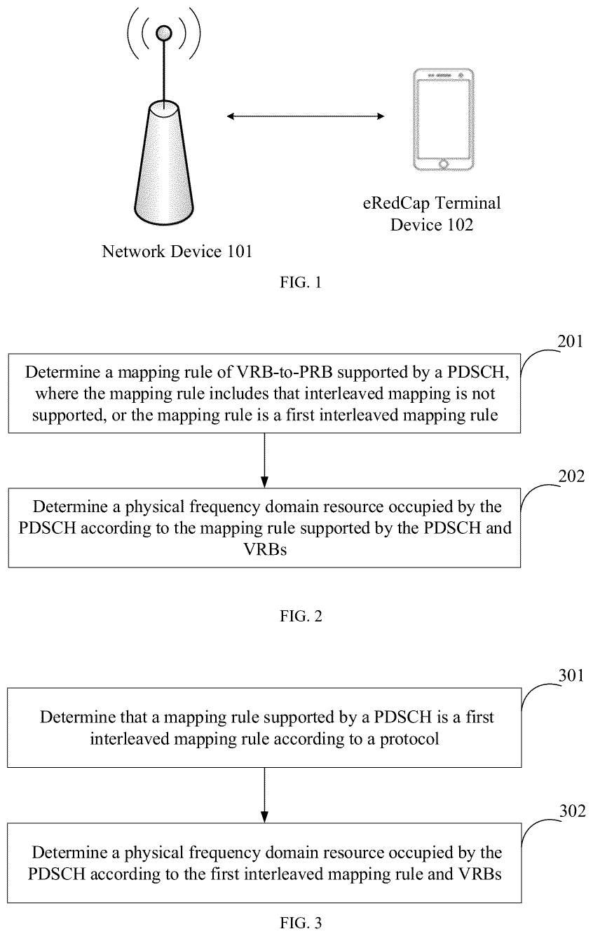

As illustrated in FIG. 1, FIG. 1 is a schematic architectural diagram of a communication system according to an embodiment of the present disclosure. The communication system may include, but is not limited to, a network device and a terminal device. The number and configuration of devices illustrated in FIG. 1 are only examples and do not constitute a limitation to the embodiments of the present disclosure. In practical applications, two or more network devices and two or more terminal devices may be included. The communication system illustrated in FIG. 1 includes a network device 101 and an eRedCap terminal device 102 as an example.

It is noted that the technical solution according to the embodiments of the present disclosure may be applied to various communication systems, for example, a long term evolution (LTE) system, a fifth generation (5G) mobile communication system, a 5G new radio system, or other future new mobile communication systems.

The network device 101 in the embodiments of the present disclosure is an entity on a network side for transmitting or receiving signals. For example, the network device 101 may be an evolved NodeB (eNB), a transmission reception point (TRP), a next generation NodeB (gNB) in a NR system, a base station in other future mobile communication systems, or an access node in a wireless fidelity (WiFi) system, etc. The specific technology and specific device form adopted by the network device are not limited in the embodiments of the present disclosure. The network device according to the embodiments of the present disclosure may be composed of a central unit (CU) and distributed units (DUs). The CU may also be referred to as a control unit. By adapting the CU-DU architecture, the network device, such as protocol layers of the base station, may be separated, placing functions of some protocol layers in the CU for centralized control, and distributing functions of the remaining part or all of protocol layers in the DU(s) for centrally control by the CU.

The eRedCap terminal device 102 in the embodiments of the present disclosure is an entity on a user side for receiving or transmitting signals, for example, a mobile phone. The terminal device may also be referred to as a terminal, user equipment (UE), a mobile station (MS), a mobile terminal (MT) and so on. The terminal device may also be a reduced capability (RedCap) UE, an evolved reduced capability (eRedCap) UE and so on. The terminal device may be a vehicle having a communication function, a smart vehicle, a mobile phone, a wearable device, a Pad, a computer having a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of the present disclosure do not limit the specific technology and specific device form adopted by the terminal device.

The terminal device 102 in the embodiments of the present disclosure can implement the method shown in any one of the embodiments of FIGS. 2 to 4, and the network device 101 can implement the method shown in any one of the embodiments of FIGS. 5 to 7.

In related technologies, a physical frequency domain resource occupied by a PDSCH of the terminal device is allocated in units of VRB, and then the terminal device maps VRBs to PRBs. A BWP with a corresponding bandwidth size of N RBs has N VRBs and N PRBs in total, numbered from 0 to N−1 respectively.

In general, non-interleaved VRB-to-PRB mapping can be adopted, or interleaved VRB-to-PRB mapping can also be adopted. For the VRB-to-PRB mapping, it is stipulated in related technologies that whether or not to enable the interleaved VRB-to-PRB mapping can be decided by a 1-bit dynamic indication in downlink control information (DCI). For example, if the indication in the DCI is 1, the interleaved mapping is enabled; if the indication in the DCI is 0, the non-interleaved mapping is enabled; or the other way around. For a system information block (SIB) 1 and other system information (OSI), the bundle size is 2 by default. For a unicast PDSCH, the bundle size is configured through radio resource control (RRC) signaling (with a value of 2 RBs or 4 RBs).

For the interleaved VRB-to-PRB mapping, a number of bundles included in a BWP can generally be determined in the following manner.

For the SIB1 and OSI, the number of the bundles is determined by the bundle size and a frequency domain bandwidth of a control resource set (CORESET) #0.

For a PDSCH carried by other common search space (CSS) and scheduled by DCI with a format 0, if the CORESET #0 is configured, the number of the bundles is determined by the bundle size and the frequency domain bandwidth of the CORESET #0; if the CORESET #0 is not configured, the number of the bundles is determined by a bandwidth size of an initial downlink (DL) BWP.

For PDSCH scheduling in other cases, the number of the bundles is determined by a bandwidth of a DL BWP and the bundle size.

In Release 18, it is proposed that a bandwidth is further reduced for the eRedCap terminal device, for example, a baseband channel bandwidth of the PDSCH of the eRedCap terminal device is reduced, which may result in a bandwidth of the BWP of the eRedCap terminal device exceeding the maximum available bandwidth of the PDSCH. If the bandwidth of the BWP or the CORESET #0 is still used to determine the number of bundles at this time, it may result in one or more actual mapped PRBs after interleaving being located on discontinuous physical frequency domain resources, which will introduce additional burden to post-fast Fourier transform (FFT) buffering of the eRedCap terminal device and increase the implementation complexity of the post-FFT buffering.

In the present disclosure, in order to avoid increasing the complexity of the post-FFT buffering process of the eRedCap terminal device, a method for determining PDSCH frequency domain resource mapping of the eRedCap terminal device is proposed. For scheduling of the PDSCH of the eRedCap terminal device, PRBs after the interleaved mapping can be prevented from being located on discontinuous physical frequency domain resources by configuring to not support the interleaved VRB-to-PRB mapping, or by performing the interleaved mapping according to a specified first interleaved mapping rule.

It can be understood that the communication system described in the embodiments of the present disclosure is for a clearer explanation of the technical solution provided in the embodiments of the present disclosure, and does not constitute a limitation on the technical solution provided in the embodiments of the present disclosure. Those skilled in the art know that with the evolution of the system architecture and the emergence of new business scenarios, the technical solution provided in the embodiments of the present disclosure is also applicable to similar technical problems.

The methods and apparatuses for determining a frequency domain resource provided by the present disclosure will be described in detail with the accompanying drawings.

As illustrated in FIG. 2, FIG. 2 is a flowchart of a method for determining a frequency domain resource provided in an embodiment of the present disclosure. It should be noted that the method in the embodiment of the present disclosure is performed by an eRedCap terminal device. As shown in FIG. 2, the method may include steps 201 and 202.

In step 201, a mapping rule of VRB-to-PRB supported by a PDSCH is determined, where the mapping rule includes that interleaved mapping is not supported, or the mapping rule is a first interleaved mapping rule.

In the present disclosure, when the eRedCap terminal device determines a physical frequency domain resource of the PDSCH, it is considered that a maximum available bandwidth of the PDSCH is always limited in a small range (for example, 5 megahertz (MHz)). In this case, if mapping rules of VRB-to-PRB in related technologies are used, it may lead to the determined physical frequency domain resource of the PDSCH exceeding the limited range. Therefore, the mapping rule of VRB-to-PRB supported by the PDSCH can be determined first.

Optionally, the mapping rule of VRB-to-PRB supported by the PDSCH determined by the eRedCap terminal device may be non-interleaved mapping, or it may also support the first interleaved mapping rule.

The first interleaved mapping rule can be a rule that any PRB resource determined through interleaved mapping must be within the maximum available bandwidth range of the PDSCH.

Optionally, the eRedCap terminal device can determine the mapping rule of VRB-to-PRB supported by the PDSCH according to a protocol. Or, the mapping rule of VRB-to-PRB supported by the PDSCH can be determined according to an indication of a network device.

Optionally, if the eRedCap terminal device determines the mapping rule of VRB-to-PRB supported by the PDSCH according to the indication of the network device, it can also be agreed by the protocol that a specified information field in the indication sent by the network device to the eRedCap terminal device can only take a preset value. For example, the protocol stipulates that the specified information field can only take a first value to indicate to the eRedCap terminal device that the interleaved mapping is not supported. Or, the protocol stipulates that the specified information field can only take a second value to indicate to the eRedCap terminal device that the interleaved mapping is supported.

Optionally, the eRedCap terminal device can also determine the mapping rule supported by the PDSCH according to a value of a specified information field in downlink control information (DCI), such as not supporting interleaved mapping or supporting the first interleaved mapping rule.

The specified information field in the DCI can be one bit or a plurality of bits in the DCI, which is not limited in the present disclosure.

Optionally, if the value of the specified information field is a first value, the eRedCap terminal device can determine that its PDSCH does not support interleaved mapping; otherwise, the eRedCap terminal device determines that its PDSCH supports interleaved mapping.

In step 202, a physical frequency domain resource occupied by the PDSCH is determined according to the mapping rule supported by the PDSCH and VRBs.

In the present disclosure, after determining the mapping rule supported by the PDSCH, for example, determining that the PDSCH does not support an interleaved mapping rule, the eRedCap terminal device can determine corresponding PRBs based on non-interleaved mapping and according to the VRBs, that is, determine the physical frequency domain resource occupied by the PDSCH.

In the present disclosure, the VRBs can be allocated VRBs, VRBs to be allocated, or VRBs expected to be allocated, which is not limited in the present disclosure.

Optionally, if the eRedCap terminal device determines that the PDSCH supports the first interleaved mapping rule, the PRBs can be determined based on the first interleaved mapping rule and the VRBs.

It can be understood that PRB resources determined by the eRedCap terminal device based on the first interleaved mapping rule are located within the maximum available bandwidth range of the PDSCH. Therefore, the problem of discontinuity of the physical frequency domain resource occupied by the PDSCH of the eRedCap terminal device determined through the interleaved mapping is avoided, so that the eRedcap terminal device can maintain data reception within a continuous maximum physical resource range (for example, 5 MHz) as much as possible, and too many additional designs are avoided for the implementation of the eRedCap terminal device.

In the present disclosure, the eRedCap terminal device first determines the mapping rule of VRB-to-PRB supported by the PDSCH, and then determines the PRB resources based on the mapping rule supported by the PDSCH and the VRBs. Thus, it is ensured that the determined physical frequency domain resource occupied by the PDSCH of the eRedCap terminal device is within the maximum available bandwidth range of the PDSCH, providing conditions for simplifying the design of the eRedCap terminal device.

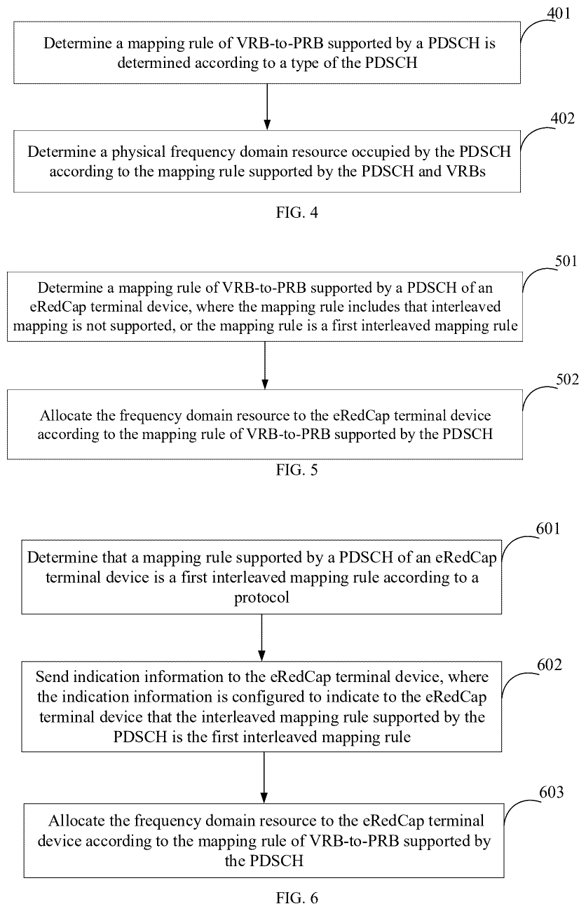

As illustrated in FIG. 3, FIG. 3 is a flowchart of a method for determining a frequency domain resource provided in an embodiment of the present disclosure. It should be noted that the method in the embodiment of the present disclosure is performed by an eRedCap terminal device. As shown in FIG. 3, the method may include steps 301 and 302.

In step 301, it is determined that a mapping rule supported by a PDSCH is a first interleaved mapping rule according to a protocol.

The first interleaved mapping rule can be a rule that any PRB resource determined through interleaved mapping must be within the maximum available bandwidth range of the PDSCH.

Optionally, the eRedCap terminal device can also determine that the mapping rule supported by the PDSCH is the first interleaved mapping rule according to indication information sent by a network device.

That is, if the network device determines that the PDSCH of the eRedCap terminal device can support interleaved mapping, the network device can indicate to the eRedCap terminal device that the PDSCH of the eRedCap terminal device supports the first interleaved mapping rule only through the indication information. Correspondingly, the eRedCap terminal device only receives the indication information sent by the network device. Thus, the eRedCap terminal device can determine that its PDSCH supports the interleaved mapping, and the supported interleaved mapping rule is the first interleaved mapping rule.

Optionally, the network device can first indicate to the eRedCap terminal device that the PDSCH of the eRedCap terminal device supports the interleaved mapping through a specified information field in DCI, and then indicate the first interleaved mapping rule to the eRedCap terminal device through indication information. The indication information and the DCI can be the same information. Or, the network device can indicate the first interleaved mapping rule to the eRedCap terminal device by using information different from the DCI indicating that the PDSCH of the eRedCap terminal device supports the interleaved mapping, which is not limited in the present disclosure.

Optionally, the above indication information can be DCI or other indication information, which is not limited in the present disclosure.

Optionally, the first interleaved mapping rule can be: a number of bundles included in a maximum available bandwidth of the PDSCH being determined according to a minimum frequency domain bandwidth value and a bundle size. That is, the number of PRB bundles included in the maximum available bandwidth of the PDSCH is determined.

In an example, the number of bundles can be determined by the following formula (1):

$$N = ⌈ W / L ⌉ \qquad ( 1 )$$

where N represents the number of bundles, W represents the minimum frequency domain bandwidth value, and L represents the bundle size.

In another example, if the minimum frequency domain bandwidth value is jointly identified by a bandwidth size and a frequency domain starting location, the number of bundles can also be calculated and determined by the following formula (2):

$$N = ⌈ ( W + ( S mod L ) ) / L ⌉ \qquad ( 2 )$$

where N represents the number of bundles, W represents a bandwidth size of the minimum frequency domain bandwidth value, S represents a frequency domain starting location of the minimum frequency domain bandwidth, and L represents the bundle size. For example, if the minimum frequency domain bandwidth is a PDSCH maximum available bandwidth value, then

$${N}_{BWP}^{s i z e}$$

is the bandwidth size of the PDSCH, and

$${N}_{BWP}^{s t a r t}$$

is an available frequency domain starting location of the PDSCH.

In another example, the number of bundles can also be calculated and determined by the following formula (3):

$$N = ⌈ ( W + ( S + {N}_{start}^{CORESET} ) mod L ) / L ⌉ \qquad ( 3 )$$

where N represents the number of bundles, W represents a bandwidth size of the minimum frequency domain bandwidth value, S represents a frequency domain starting location of the minimum frequency domain bandwidth,

$${N}_{start}^{CORESET}$$

represents a frequency domain starting location of a control resource set (CORESET) #0 carrying scheduling DCI, and L represents the bundle size.

Optionally, for a PDSCH carrying a system information block (SIB) 1 and other system information (OSI), a minimum value of the PDSCH maximum available bandwidth value and a bandwidth value of the CORESET #0 can be determined as the minimum frequency domain bandwidth value.

Or, for a PDSCH carried by a common search space (CSS) and scheduled by DCI with a format 0, if the CORESET #0 is configured, a minimum value of the PDSCH maximum available bandwidth value and a bandwidth value of the CORESET #0 can be determined as the minimum frequency domain bandwidth value.

For example, if the PDSCH maximum available bandwidth value is 5 MHz and the bandwidth value of the CORESET #0 is 20 MHz, for the PDSCH carrying the SIB1 and OSI, or the PDSCH carried by the CSS and scheduled by DCI format 0-0, the minimum frequency domain bandwidth value can be determined to be 5 MHz. Or, if the PDSCH maximum available bandwidth value is 5 MHz and the bandwidth value of the CORESET #0 is 2 MHz, then the minimum frequency domain bandwidth value can be determined to be 2 MHz.

Optionally, for the PDSCH carried by the CSS and scheduled by the DCI with the format 0, if the CORESET #0 is not configured, a minimum value of the PDSCH maximum available bandwidth value and a frequency domain bandwidth value of an initial downlink (DL) bandwidth part (BWP) can be determined as the minimum frequency domain bandwidth value.

For example, if the PDSCH maximum available bandwidth value is 5 MHz and the frequency domain bandwidth value of the initial DL BWP is 10 MHz, for the PDSCH scheduled by DCI format 0-0, the minimum frequency domain bandwidth value can be determined to be 5 MHz. Or, if the PDSCH maximum available bandwidth value is 5 MHz and the frequency domain bandwidth value of the initial DL BWP is 2 MHz, then the minimum frequency domain bandwidth value can be determined to be 2 MHz.

Optionally, for a unicast PDSCH, a minimum value of the PDSCH maximum available bandwidth value and a frequency domain bandwidth value of a dedicated DL BWP can be determined as the minimum frequency domain bandwidth value.

The PDSCH maximum available bandwidth value, i.e., the maximum available bandwidth value of the PDSCH, can be represented by a frequency value, for example, 5 MHz.

Optionally, when the maximum available bandwidth of the PDSCH is indicated by RB, the maximum available bandwidth value of the PDSCH can also be the number of RBs. For example, when sub-carrier spacing (SCS) is 15 kilohertz (kHz), the PDSCH can include up to 28 PRBs; when the SCS is 30 kHz, the PDSCH can include up to 30 PRBs.

Or, when the SCS is 15 kHz, the PDSCH can include up to 27 PRBs; when the SCS is 30 kHz, the PDSCH can include up to 13 PRBs.

Or, when the SCS is 15 kHz, the PDSCH can include up to 25 PRBs; when the SCS is 30 kHz, the PDSCH can include up to 12 PRBs.

Or, when the SCS is 15 kHz, the PDSCH can include up to 25 PRBs; when the SCS is 30 kHz, the PDSCH can include up to 11 PRBs.

It should be noted that when the above SCS values are different, the maximum number of PRBs that can be included in the PDSCH and the combination form are only illustrative and cannot be used as a limitation on the way in which the maximum available bandwidth value of the PDSCH is represented by the number of PRBs in the present disclosure.

In step 302, a physical frequency domain resource occupied by the PDSCH is determined according to the first interleaved mapping rule and VRBs.

For example, for the PDSCH carrying the SIB1, if the maximum available bandwidth value of the PDSCH is 25 PRBs, the bandwidth value of the CORESET #0 is 100 PRBs, and the bundle size is 2, then it can be determined that the number of PRB bundles included in the maximum available bandwidth of the PDSCH is ┌25/2┐, that is, the maximum baseband physical frequency domain range of the PDSCH includes 13 PRB bundles.

Then, the eRadCap terminal device can perform interleaved mapping according to the determined number of PRB bundles included in the maximum available bandwidth of the PDSCH and VRBs, so as to determine PRBs occupied by the PDSCH.

It can be understood that since in the first interleaved mapping rule, the number of PRB bundles included in the maximum available bandwidth of the PDSCH is determined based on the minimum frequency domain bandwidth value, PRB resources determined after mapping based on the first interleaved mapping rule are located within the maximum available bandwidth range of the PDSCH.

In addition, in the present disclosure, the eRadCap terminal device needs to first determine a location of the frequency domain resource currently occupied by its PDSCH when determining the PRB resources occupied by the PDSCH based on the first interleaved mapping rule. The location of the frequency domain resource occupied by the PDSCH of the eRadCap terminal device can be fixed, for example, a fixed frequency domain resource location is agreed by a protocol. Or, the network device can also dynamically allocate the frequency domain resource location to the eRadCap terminal device.

Optionally, the eRadCap terminal device can determine the location of the PRB resources currently occupied by its PDSCH according to a protocol. For example, the protocol stipulates that a starting RB of the PDSCH bandwidth is aligned with a starting RB of the BWP or CORESET #0; or, the highest RB of the PDSCH channel bandwidth with is aligned with the highest RB of the BWP; or, a center frequency domain location of the PDSCH channel bandwidth is aligned with a center frequency domain location of the BWP.

It should be noted that if the protocol specifies the highest RB or the center frequency domain location of the PDSCH channel bandwidth, the eRadCap terminal device also needs to derive and calculate a starting RB location of the PDSCH channel bandwidth. Optionally, the eRadCap terminal device can calculate the starting RB location by subtracting 5 MHz (or how many RBs) from the highest RB location. It should be noted that if the calculated starting RB is a second RB in the bundle, then the calculated starting RB location needs to be subtracted by one.

Optionally, the eRadCap terminal device can also calculate the starting RB location by subtracting (5 MHz/2) (or subtracting a maximum number of RBs included in a half of the PDSCH) from a center RB location, etc., which is not limited in the present disclosure.

Optionally, the eRadCap terminal device can also determine the location of the PRB resources currently occupied by its PDSCH according to an indication message, for example, RRC signaling, which is not limited in the present disclosure.

In the present disclosure, the eRadCap terminal device first determines that the mapping rule of VRB-to-PRB supported by its PDSCH is the first interleaved mapping rule according to the protocol. Then, based on the first interleaved mapping rule and the VRBs, the PRBs occupied by the PDSCH can be determined through the interleaved mapping. Thus, it is ensured that the determined physical frequency domain resource occupied by the PDSCH of the eRedCap terminal device is within the maximum available bandwidth range of the PDSCH, providing conditions for simplifying the design of the eRedCap terminal device.

As illustrated in FIG. 4, FIG. 4 is a flowchart of a method for determining a frequency domain resource provided in an embodiment of the present disclosure. It should be noted that the method in the embodiment of the present disclosure is performed by an eRedCap terminal device. As shown in FIG. 4, the method may include steps 401 and 402.

In step 401, a mapping rule of VRB-to-PRB supported by a PDSCH is determined according to a type of the PDSCH.

In the present disclosure, considering that types of the PDSCH may be different, for example, the PDSCH can be divided into the PDSCH carrying a SIB1 or the PDSCH carrying a random access message (for example, a second random access message (message2, msg2), or a fourth random access message (message4, msg4), etc.) according to different information the PDSCH carries. Therefore, in the present disclosure, when determining the mapping rule of VRB-to-PRB supported by a certain PDSCH, the eRedCap terminal device can determine the mapping rule of VRB-to-PRB supported by the PDSCH according to the type of the PDSCH.

Optionally, when determining that the PDSCH is any one of the following types of the PDSCH: a PDSCH carrying a system information block (SIB) 1, a PDSCH carrying other system information (OSI), a PDSCH carrying a random access message, or a PDSCH carrying a paging message, the eRedCap terminal device can determine that the mapping rule of VRB-to-PRB supported by the PDSCH is that the interleaved mapping is not supported. The random access message mentioned above can be one or two of msg2 and msg4, which is not limited in the present disclosure.

Optionally, when determining that the PDSCH is any one of the following types of the PDSCH: a unicast PDSCH, a PDSCH carrying a random access message, or a PDSCH carrying a paging message, the eRedCap terminal device can determine that the mapping rule of VRB-to-PRB supported by the PDSCH is the first interleaved mapping rule. The random access message mentioned above can be one or two of msg2 and msg4, which is not limited in the present disclosure.

That is, the eRedCap terminal device can determine that the PDSCH carrying the SIB1 does not support interleaved VRB-to-PRB mapping, and the unicast PDSCH supports the first interleaved mapping rule; or, the PDSCH carrying msg2 and the PDSCH carrying msg4 do not support interleaved VRB-to-PRB mapping; or, both the PDSCH carrying msg2 and the PDSCH carrying msg4 support the first interleaved mapping rule of VRB-to-PRB, which is not limited in the present disclosure.

The first interleaved mapping rule can refer to the detailed description of any embodiment in the present disclosure, and will not be repeated here.

In step 402, a physical frequency domain resource occupied by the PDSCH is determined according to the mapping rule supported by the PDSCH and VRBs.

The specific implementation form of step 402 can refer to the detailed description of any embodiment in the present disclosure, and will not be repeated here.

In the present disclosure, the eRedCap terminal device can first determine the type of the PDSCH, and then determine the mapping rule of VRB-to-PRB supported by the PDSCH according to the type of the PDSCH. Then, based on the determined mapping rule supported by the PDSCH and the VRBs, the physical frequency domain resource occupied by the PDSCH can be determined. Thus, it is ensured that the determined physical frequency domain resource occupied by the PDSCH of the eRedCap terminal device is within the maximum available bandwidth range of the PDSCH, providing conditions for simplifying the design of the eRedCap terminal device.

As illustrated in FIG. 5, FIG. 5 is a flowchart of a method for determining a frequency domain resource provided in an embodiment of the present disclosure. It should be noted that the method in the embodiment of the present disclosure is performed by a network device. As shown in FIG. 5, the method may include steps 501 and 502.

In step 501, a mapping rule of VRB-to-PRB supported by a PDSCH of an eRedCap terminal device is determined, where the mapping rule includes that interleaved mapping is not supported, or the mapping rule is a first interleaved mapping rule.

In the present disclosure, when the network device allocates the frequency domain resource to the PDSCH of the eRedCap terminal device, it is considered that a maximum available bandwidth of the PDSCH of the eRedCap terminal device is always limited in a small range (for example, always limited to 5 MHz). In this case, if mapping rules of VRB-to-PRB in related technologies are used, it may lead to the physical frequency domain resource of the PDSCH determined by the eRedCap terminal device exceeding the limited range. Therefore, the mapping rule of VRB-to-PRB supported by the PDSCH of the eRedCap terminal device can be determined first.

Optionally, the network device can determine the mapping rule of VRB-to-PRB supported by the PDSCH of the eRedCap terminal device according to a protocol. For example, according to the protocol agreement, it is determined that the PDSCH of the eRedCap terminal device does not support an interleaved mapping rule of VRB-to-PRB. Or, according to the protocol agreement, it is determined that the mapping rule supported by the PDSCH of the eRedCap terminal device is the first interleaved mapping rule.

The first interleaved mapping rule can be a rule that any PRB resource determined by the eRedCap terminal device through interleaved mapping must be within the maximum available bandwidth range of the PDSCH.

In step 502, the frequency domain resource is allocated to the eRedCap terminal device according to the mapping rule of VRB-to-PRB supported by the PDSCH.

In the present disclosure, after determining the mapping rule of VRB-to-PRB supported by the PDSCH of the eRedCap terminal device, the network device can allocate the frequency domain resource to the eRedCap terminal device based on the mapping rule supported by the PDSCH, that is, allocate VRB resources.

Optionally, if it is determined that the PDSCH of the eRedCap terminal device does not support the interleaved VRB-to-PRB mapping, the network device can allocate VRBs to the eRedCap terminal device based on a maximum available bandwidth of the PDSCH of the eRedCap terminal device.

Or, if the network device determines that the mapping rule of VRB-to-PRB supported by the PDSCH of the eRedCap terminal device is the first interleaved mapping rule, based on the first interleaved mapping rule, a number of bundles (i.e., the number of VRBs) included in the maximum available bandwidth of the PDSCH of the eRedCap terminal device can be determined, and VRBs can be allocated to the eRedCap terminal device. Since the number of bundles included in the maximum available bandwidth of the PDSCH is determined based on the first interleaved mapping rule, it is ensured that PRB resources mapped by the VRBs allocated to the terminal device after the interleaved mapping are within the maximum available bandwidth range of the PDSCH. That is, the frequency domain resource allocated to the terminal device is located on the continuous physical frequency domain resource, so that the eRedcap terminal device can maintain data reception within a continuous maximum physical resource range (for example, 5 MHz) as much as possible, and too many additional designs are avoided for the implementation of the eRedCap terminal device.

In the present disclosure, the network device first determines the mapping rule of VRB-to-PRB supported by the PDSCH of the eRedCap terminal device, and then allocates the frequency domain resource to the eRedCap terminal device based on the mapping rule of supported by the PDSCH. Thus, it is ensured that the frequency domain resource allocated for the PDSCH of the eRedCap terminal device is within the maximum available bandwidth range of the PDSCH after mapping, providing conditions for simplifying the design of the eRedCap terminal device.

As illustrated in FIG. 6, FIG. 6 is a flowchart of a method for determining a frequency domain resource provided in an embodiment of the present disclosure. It should be noted that the method in the embodiment of the present disclosure is performed by a network device. As shown in FIG. 6, the method may include steps 601 to 603.

In step 601, it is determined that a mapping rule supported by a PDSCH of an eRedCap terminal device is a first interleaved mapping rule according to a protocol.

The first interleaved mapping rule can be a rule that any PRB resource determined by the eRedCap terminal device through interleaved mapping must be within a maximum available bandwidth range of the PDSCH.

Optionally, the first interleaved mapping rule can be: a number of bundles included in a maximum available bandwidth of the PDSCH being determined according to a minimum frequency domain bandwidth value and a bundle size. That is, a number of PRB bundles included in the maximum available bandwidth of the PDSCH of the eRedCap terminal device is determined.

The calculation manner of the number of bundles can refer to the detailed description of any embodiment in the present disclosure, and will not be repeated here.

Optionally, for a PDSCH carrying a system information block (SIB) 1 and other system information (OSI), a minimum value of a PDSCH maximum available bandwidth value and a bandwidth value of a CORESET #0 can be determined as the minimum frequency domain bandwidth value.

Or, for a PDSCH carried by a common search space (CSS) and scheduled by DCI with a format 0, if the CORESET #0 is configured, a minimum value of the PDSCH maximum available bandwidth value and a bandwidth value of the CORESET #0 can be determined as the minimum frequency domain bandwidth value.

For example, if the PDSCH maximum available bandwidth value is 5 MHz and the bandwidth value of the CORESET #0 is 20 MHz, for the PDSCH carrying the SIB1 and OSI, or the PDSCH carried by the CSS and scheduled by DCI format 0-0, the minimum frequency domain bandwidth value can be determined to be 5 MHz. Or, if the PDSCH maximum available bandwidth value is 5 MHz and the bandwidth value of the CORESET #0 is 2 MHz, then the minimum frequency domain bandwidth value can be determined to be 2 MHz.

Optionally, for the PDSCH carried by the CSS and scheduled by the DCI with the format 0, if the CORESET #0 is not configured, a minimum value of the PDSCH maximum available bandwidth value and a frequency domain bandwidth value of an initial downlink (DL) bandwidth part (BWP) can be determined as the minimum frequency domain bandwidth value.

For example, if the PDSCH maximum available bandwidth value is 5 MHz and the frequency domain bandwidth value of the initial DL BWP is 10 MHz, for the PDSCH scheduled by DCI format 0-0, the minimum frequency domain bandwidth value can be determined to be 5 MHz. Or, if the PDSCH maximum available bandwidth value is 5 MHz and the frequency domain bandwidth value of the initial DL BWP is 2 MHz, then the minimum frequency domain bandwidth value can be determined to be 2 MHz.

Optionally, for a unicast PDSCH, a minimum value of the PDSCH maximum available bandwidth value and a frequency domain bandwidth value of a dedicated DL BWP can be determined as the minimum frequency domain bandwidth value.

The PDSCH maximum available bandwidth value, i.e., the maximum available bandwidth value of the PDSCH, can be represented by a frequency value, for example, 5 MHz.

Optionally, when the maximum available bandwidth of the PDSCH is indicated by RB, the maximum available bandwidth value of the PDSCH can also be the number of RBs. For example, when sub-carrier spacing (SCS) is 15 kilohertz (kHz), the PDSCH can include up to 28 PRBs; when the SCS is 30 kHz, the PDSCH can include up to 30 PRBs.

Or, when the SCS is 15 kHz, the PDSCH can include up to 27 PRBs; when the SCS is 30 kHz, the PDSCH can include up to 13 PRBs.

Or, when the SCS is 15 kHz, the PDSCH can include up to 25 PRBs; when the SCS is 30 kHz, the PDSCH can include up to 12 PRBs.

Or, when the SCS is 15 kHz, the PDSCH can include up to 25 PRBs; when the SCS is 30 kHz, the PDSCH can include up to 11 PRBs.

It should be noted that when the above SCS values are different, the maximum number of PRBs that can be included in the PDSCH and the combination form are only illustrative and cannot be used as a limitation on the way in which the maximum available bandwidth value of the PDSCH is represented by the number of PRBs in the present disclosure.

In the present disclosure, the network device can send DCI to the eRedCap terminal device after determining that the eRedCap terminal device supports the first interleaved mapping rule. A value of a specified information field in the DCI is used to indicate that the PDSCH supports interleaved mapping.

Optionally, if the network device determines that the eRedCap terminal device does not support interleaved mapping, the specified information field in the DCI can also be used to indicate that the PDSCH does not support the interleaved mapping. For example, when the value of the specified information field value in the DCI is a first value, it indicates that the PDSCH supports the interleaved mapping, otherwise it indicates that the PDSCH does not support the interleaved mapping.

In step 602, indication information is sent to the eRedCap terminal device, where the indication information is configured to indicate to the eRedCap terminal device that the interleaved mapping rule supported by the PDSCH is the first interleaved mapping rule.

In the present disclosure, after determining that the interleaved mapping rule supported by the PDSCH of the eRedCap terminal device is the first interleaved mapping rule, the network device can indicate the first interleaved mapping rule to the eRedCap terminal device through the indication information.

Optionally, the network device can indicate to the eRedCap terminal device that the PDSCH of the eRedCap terminal device supports the interleaved mapping through a specified information field in DCI, and then indicate the first interleaved mapping rule to the eRedCap terminal device through indication information. That is, the indication information and the DCI can be the same information. Or, the network device can indicate the first interleaved mapping rule to the eRedCap terminal device by using information different from the DCI indicating that the PDSCH supports the interleaved mapping, which is not limited in the present disclosure.

Or, when determining that the PDSCH of the eRedCap terminal device supports the first interleaved mapping rule, the network device may not send DCI to the eRedCap terminal device, but only send the indication information. The first interleaved mapping rule is directly indicated to the eRedCap terminal device through the indication information, so that the eRedCap terminal device can determine that its PDSCH supports interleaved mapping and that the supported mapping rule is the first interleaved mapping rule.

Optionally, the above indication information can be DCI or other indication information, which is not limited in the present disclosure.

Optionally, in the present disclosure, after determining the first interleaved mapping rule supported by the PDSCH of the eRedCap terminal device according to the protocol, the network device may not indicate it to the eRedCap terminal device, but the eRedCap terminal device itself determines the first interleaved mapping rule according to the protocol.

That is, after determining the first interleaved mapping rule according to the protocol, the network device can send the DCI to the eRedCap terminal device to indicate that the PDSCH of the eRedCap terminal device supports interleaved mapping. Then, the eRedCap terminal device determines the first interleaved mapping rule according to the protocol.

Or, after determining the first interleaved mapping rule according to the protocol, the network device may not send any information to the eRedCap terminal device. The eRedCap terminal device may determine whether its PDSCH supports VRB-to-PRB mapping and the interleaved mapping rule when it supports interleaved mapping according to the protocol, which is not limited in the present disclosure.

Optionally, it can also be agreed by the protocol that a specified information field in the indication sent by the network device to the eRedCap terminal device can only take a preset value. For example, the protocol stipulates that the specified information field can only take a first value to indicate to the eRedCap terminal device that the interleaved mapping is not supported. Or, the protocol stipulates that the specified information field can only take a second value to indicate to the eRedCap terminal device that the interleaved mapping is supported, etc., which is not limited in the present disclosure.

In step 603, the frequency domain resource is allocated to the eRedCap terminal device according to the mapping rule of VRB-to-PRB supported by the PDSCH.

For example, for the PDSCH carrying the SIB1, if the maximum available bandwidth value of the PDSCH is 25 PRBs, the bandwidth value of the CORESET #0 is 100 PRBs, and the bundle size is 2, then it can be determined that the number of VRB bundles included in the maximum available bandwidth of the PDSCH is ┌25/2┐, that is, the maximum baseband physical frequency domain range of the PDSCH includes 13 VRB bundles.

Afterwards, the network device can allocate VRBs occupied by the PDSCH to the eRadCap terminal device according to the determined number of VRB bundles included in the maximum available bandwidth of the PDSCH.

It can be understood that since in the first interleaved mapping rule, the number of PRB bundles included in the maximum available bandwidth of the PDSCH is determined based on the minimum frequency domain bandwidth value, VRB resources allocated to the eRadCap terminal device based on the first interleaved mapping rule must be within the maximum available bandwidth range of the PDSCH.

In addition, when determining the VRB resources occupied by the PDSCH of the eRadCap terminal device based on the first interleaved mapping rule, the network device needs to first determine a location of the frequency domain resource currently occupied by the PDSCH of the eRadCap terminal device. The location of the frequency domain resource occupied by the PDSCH of the eRadCap terminal device can be fixed, for example, a fixed frequency domain resource location is agreed by a protocol. Or, the network device can also dynamically allocate the frequency domain resource location to the eRadCap terminal device.

Optionally, the network device can determine the location of the VRB resources currently occupied by the PDSCH of the eRadCap terminal device according to a protocol. For example, the protocol stipulates that a starting RB of the PDSCH bandwidth is aligned with a starting RB of the BWP or CORESET #0; or, the highest RB of the PDSCH channel bandwidth with is aligned with the highest RB of the BWP; or, a center frequency domain location of the PDSCH channel bandwidth is aligned with a center frequency domain location of the BWP.

It should be noted that if the protocol specifies the highest RB or the center frequency domain location of the PDSCH channel bandwidth, the network device also needs to derive and calculate a starting RB location of the PDSCH channel bandwidth. Optionally, the network device can calculate the starting RB location by subtracting 5 MHz (or how many RBs) from the highest RB location. It should be noted that if the calculated starting RB is a second RB in the bundle, then the calculated starting RB location needs to be subtracted by one.

Optionally, the network device can also calculate the starting RB location by subtracting (5 MHz/2) (or subtracting a maximum number of RBs included in a half of the PDSCH) from a center RB location, etc., which is not limited in the present disclosure.

Optionally, the network device can also dynamically schedule the frequency domain resource occupied by the PDSCH for the eRadCap terminal device according to information such as a location of the eRadCap terminal device.

Optionally, after determining the location of the frequency domain resource currently occupied by the PDSCH of the eRadCap terminal device, the network device can indicate the location of the PRB resources currently occupied by the PDSCH to the eRadCap terminal device through an indication message, for example, RRC signaling. Or, if the network device determines the location of the frequency domain resource occupied by the PDSCH of the eRadCap terminal device based on a protocol, the location can also be determined by the eRadCap terminal device according to the protocol without indicating to the eRadCap terminal device, which is not limited in the present disclosure.

The specific implementation of step 603 can refer to the detailed description of any embodiment in the present disclosure, and will not be repeated here.

In the present disclosure, after determining that the mapping rule supported by the PDSCH of the eRedCap terminal device is the first interleaved mapping rule according to the protocol, the network device first indicates the first interleaved mapping rule to the eRedCap terminal device through indication information, and then determines VRBs to be allocated to the eRedCap terminal device according to the first interleaved mapping rule. Thus, it is ensured that the frequency domain resource allocated for the PDSCH of the eRedCap terminal device is within the maximum available bandwidth range of the PDSCH after mapping, providing conditions for simplifying the design of the eRedCap terminal device.

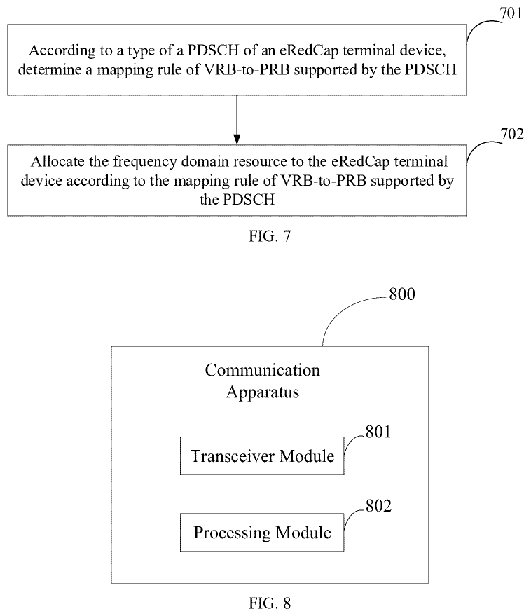

As illustrated in FIG. 7, FIG. 7 is a flowchart of a method for determining a frequency domain resource provided in an embodiment of the present disclosure. It should be noted that the method in the embodiment of the present disclosure is performed by a network device. As shown in FIG. 7, the method may include steps 701 and 702.

In step 701, according to a type of a PDSCH of an eRedCap terminal device, a mapping rule of VRB-to-PRB supported by the PDSCH is determined.

In the present disclosure, considering that types of the PDSCH of the eRedCap terminal device may be different, for example, the PDSCH can be divided into the PDSCH carrying a SIB1 or the PDSCH carrying a random access message (for example, a second random access message (message2, msg2), or a fourth random access message (message4, msg4), etc.) according to different information the PDSCH carries. Therefore, in the present disclosure, when determining the mapping rule of VRB-to-PRB supported by a certain PDSCH of the eRedCap terminal device, the network device can determine the mapping rule of VRB-to-PRB supported by the PDSCH according to the type of the PDSCH.

Optionally, when determining that the PDSCH of the eRedCap terminal device is any one of the following types of the PDSCH: a PDSCH carrying a system information block (SIB) 1, a PDSCH carrying other system information (OSI), a PDSCH carrying a random access message, or a PDSCH carrying a paging message, the network device can determine that the mapping rule of VRB-to-PRB supported by the PDSCH is that the interleaved mapping is not supported. The random access message mentioned above can be one or two of msg2 and msg4, which is not limited in the present disclosure.

Optionally, when determining that the PDSCH of the eRedCap terminal device is any one of the following types of the PDSCH: a unicast PDSCH, a PDSCH carrying a random access message, or a PDSCH carrying a paging message, the network device can determine that the mapping rule of VRB-to-PRB supported by the PDSCH is the first interleaved mapping rule. The random access message mentioned above can be one or two of msg2 and msg4, which is not limited in the present disclosure.

That is, the network device can determine that one of the PDSCH carrying msg2 and the PDSCH carrying msg4 of the eRedCap terminal device does not support interleaved VRB-to-PRB mapping, and the other PDSCH supports the first interleaved mapping rule; or, the PDSCH carrying msg2 and the PDSCH carrying msg4 do not support interleaved VRB-to-PRB mapping; or, both the PDSCH carrying msg2 and the PDSCH carrying msg4 support the first interleaved mapping rule of VRB-to-PRB, which is not limited in the present disclosure.

The first interleaved mapping rule can refer to the detailed description of any embodiment in the present disclosure, and will not be repeated here.

In step 702, the frequency domain resource is allocated to the eRedCap terminal device according to the mapping rule of VRB-to-PRB supported by the PDSCH.

The specific implementation of step 702 can refer to the detailed description of any embodiment in the present disclosure, and will not be repeated here.

In the present disclosure, the network device first determines the mapping rule supported by the PDSCH according to the type of the PDSCH of the eRedCap terminal device, and then determines the VRBs to be allocated to the eRedCap terminal device according to the determined supported mapping rule. Thus, it is ensured that the frequency domain resource allocated for the PDSCH of the eRedCap terminal device is within the maximum available bandwidth range of the PDSCH after mapping, providing conditions for simplifying the design of the eRedCap terminal device.

Corresponding to the methods for determining a frequency domain resource provided in the above embodiments, the present disclosure also provides a communication apparatus. Since the communication apparatus provided in the present disclosure corresponds to the methods provided in the above embodiments, the implementation of the methods for determining the frequency domain resource is also applicable to the communication apparatus provided in the following embodiments, and will not be described in detail in the following embodiments.

As illustrated in FIG. 8, FIG. 8 is a schematic structural diagram of a communication apparatus according to an embodiment of the present disclosure. The communication apparatus 800 shown in FIG. 8 may include a transceiver module 801 and a processing module 802. The transceiver module 801 may include a sending module and/or a receiving module. The sending module is used to implement a sending function, and the receiving module is used to implement a receiving function. The transceiver module 801 may implement the sending function and/or the receiving function.

It can be understood that the communication apparatus 800 can be an eRedCap terminal device, or an apparatus in an eRedCap terminal device, or an apparatus that can be used in conjunction with an eRedCap terminal device.

The communication apparatus 800 is on the eRedCap terminal device side, where: the processing module 802 is configured to determine a mapping rule of virtual resource block (VRB)-to-physical resource block (PRB) supported by a physical downlink shared channel (PDSCH), where the mapping rule includes that interleaved mapping is not supported, or the mapping rule is a first interleaved mapping rule; and where the processing module 802 is further configured to determine a physical frequency domain resource occupied by the PDSCH according to the mapping rule supported by the PDSCH and VRBs.

Optionally, the processing module 802 is further configured to determine the mapping rule of VRB-to-PRB supported by the PDSCH according to a type of the PDSCH.

Optionally, the processing module 802 is further configured to: in response to the PDSCH being any one of following types of the PDSCH: a PDSCH carrying a system information block (SIB) 1, a PDSCH carrying other system information (OSI), a PDSCH carrying a random access message, or a PDSCH carrying a paging message, determine that the mapping rule of VRB-to-PRB supported by the PDSCH is that the interleaved mapping is not supported; or in response to the PDSCH being any one of following types of the PDSCH: a unicast PDSCH, a PDSCH carrying a random access message, or a PDSCH carrying a paging message, determine that the mapping rule of VRB-to-PRB supported by the PDSCH is the first interleaved mapping rule.

Optionally, the processing module 802 is further configured to: determine that the PDSCH does not support an interleaved mapping rule of VRB-to-PRB according to a protocol; or determine that the PDSCH does not support the interleaved mapping according to a value of a specified information field in downlink control information (DCI); or determine that the mapping rule supported by the PDSCH is the first interleaved mapping rule according to a protocol; or determine that the mapping rule supported by the PDSCH is the first interleaved mapping rule according to indication information sent by a network device.

Optionally, the first interleaved mapping rule includes: a number of bundles included in a maximum available bandwidth of the PDSCH being determined according to a minimum frequency domain bandwidth value and a bundle size.

Optionally, the processing module 802 is further configured to: for a PDSCH carrying a system information block (SIB) 1 and other system information (OSI), determine a minimum value of a PDSCH maximum available bandwidth value and a bandwidth value of a control resource set (CORESET) #0 as the minimum frequency domain bandwidth value; or for a PDSCH carried by a common search space (CSS) and scheduled by downlink control information (DCI) with a format 0, with the CORESET #0 being configured, determine a minimum value of the PDSCH maximum available bandwidth value and the bandwidth value of the CORESET #0 as the minimum frequency domain bandwidth value; or for the PDSCH carried by the CSS and scheduled by the DCI with the format 0, with the CORESET #0 being not configured, determine a minimum value of the PDSCH maximum available bandwidth value and a frequency domain bandwidth value of an initial downlink (DL) bandwidth part (BWP) as the minimum frequency domain bandwidth value; or for a unicast PDSCH, determine a minimum value of the PDSCH maximum available bandwidth value and a frequency domain bandwidth value of a dedicated DL BWP as the minimum frequency domain bandwidth value.

Optionally, the PDSCH maximum available bandwidth value is a maximum available bandwidth value of the PDSCH.

In the present disclosure, the eRedCap terminal device first determines the mapping rule of VRB-to-PRB supported by the PDSCH, and then determines the PRB resources based on the mapping rule supported by the PDSCH and the VRBs. Thus, it is ensured that the determined physical frequency domain resource occupied by the PDSCH of the eRedCap terminal device is within the maximum available bandwidth range of the PDSCH, providing conditions for simplifying the design of the eRedCap terminal device.

The communication apparatus 800 is on the network device side, where: the processing module 802 is configured to determine a mapping rule of virtual resource block (VRB)-to-physical resource block (PRB) supported by a physical downlink shared channel (PDSCH) of an evolved reduced capability (eRedCap) terminal device, where the mapping rule includes that interleaved mapping is not supported, or the mapping rule is a first interleaved mapping rule; and the transceiver module 801 is configured to allocate a frequency domain resource to the eRedCap terminal device according to the mapping rule of VRB-to-PRB supported by the PDSCH.

Optionally, the processing module 802 is further configured to determine the mapping rule of VRB-to-PRB supported by the PDSCH according to a type of the PDSCH.

Optionally, the processing module 802 is further configured to: in response to the PDSCH being a PDSCH for scheduling a system information block (SIB) 1 and other system information (OSI), determine that the mapping rule of VRB-to-PRB supported by the PDSCH is that the interleaved mapping is not supported; or in response to the PDSCH being any one of following types of the PDSCH: a unicast PDSCH, a PDSCH carrying a random access response (RAR), or a PDSCH carrying a fourth access message (msg4), determine that the mapping rule of VRB-to-PRB supported by the PDSCH is the first interleaved mapping rule.

Optionally, the processing module 802 is further configured to: determine that the PDSCH of the eRedCap terminal device does not support an interleaved mapping rule of VRB-to-PRB according to a protocol; or determine that the mapping rule supported by the PDSCH of the eRedCap terminal is the first interleaved mapping rule according to a protocol.

Optionally, the transceiver module 801 is further configured to: send downlink control information (DCI) to the eRedCap terminal device, where a specified information field in the DCI is configured to indicate that the PDSCH does not support the interleaved mapping or supports the interleaved mapping; and/or, send indication information to the eRedCap terminal device, where the indication information is configured to indicate to the eRedCap terminal device that the interleaved mapping rule supported by the PDSCH is the first interleaved mapping rule.

Optionally, the first interleaved mapping rule includes: a number of bundles included in a maximum available bandwidth of the PDSCH being determined according to a minimum frequency domain bandwidth value and a bundle size.

Optionally, the processing module 802 is further configured to: for a PDSCH carrying a system information block (SIB) 1 and other system information (OSI), determine a minimum value of a PDSCH maximum available bandwidth value and a bandwidth value of a control resource set (CORESET) #0 as the minimum frequency domain bandwidth value; or for a PDSCH carried by a common search space (CSS) and scheduled by downlink control information (DCI) with a format 0, with the CORESET #0 being configured, determine a minimum value of the PDSCH maximum available bandwidth value and the bandwidth value of the CORESET #0 as the minimum frequency domain bandwidth value; or for the PDSCH carried by the CSS and scheduled by the DCI with the format 0, with the CORESET #0 being not configured, determine a minimum value of the PDSCH maximum available bandwidth value and a frequency domain bandwidth value of an initial downlink (DL) bandwidth part (BWP) as the minimum frequency domain bandwidth value; or for a unicast PDSCH, determine a minimum value of the PDSCH maximum available bandwidth value and a frequency domain bandwidth value of a dedicated DL BWP as the minimum frequency domain bandwidth value.

Optionally, the PDSCH maximum available bandwidth value is a maximum available bandwidth value of the PDSCH.

In the present disclosure, the network device first determines the mapping rule of VRB-to-PRB supported by the PDSCH of the eRedCap terminal device, and then allocates the frequency domain resource to the eRedCap terminal device based on the mapping rule of supported by the PDSCH. Thus, it is ensured that the frequency domain resource allocated for the PDSCH of the eRedCap terminal device is within the maximum available bandwidth range of the PDSCH after mapping, providing conditions for simplifying the design of the eRedCap terminal device.

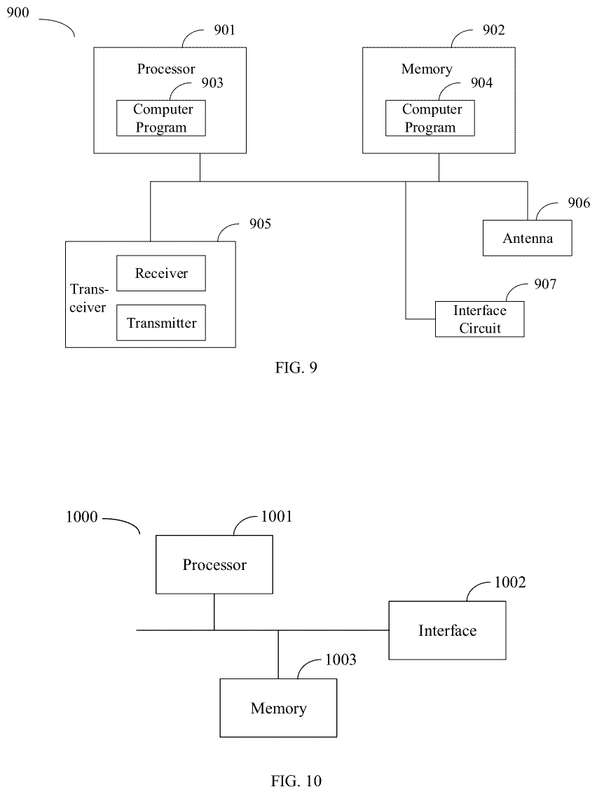

Referring to FIG. 9, FIG. 9 is a schematic structural diagram of another communication apparatus provided in an embodiment of the present disclosure. The communication apparatus 900 may be an eRedCap terminal device, or a chip, a chip system, a processor or the like that supports the eRedCap terminal device to implement the above methods. Or, the communication apparatus 900 may also be a network device, or a chip, a chip system, a processor or the like that supports the network device to implement the above methods. The apparatus may be used to implement the methods described in the above method embodiments, and for details, the descriptions in the above method embodiments may be referred to.

The communication apparatus 900 may include one or more processors 901. The processor 901 may be a general-purpose processor or a special-purpose processor. For example, the processor 901 may be a baseband processor or a central processing unit. The baseband processor may be used to process the communication protocol and communication data, and the central processing unit may be used to control the communication apparatus (for example, a base station, a baseband chip, a terminal device, a terminal device chip, a DU or a CU, etc.), execute a computer program and process data of the computer program.

Optionally, the communication apparatus 900 may further include one or more memories 902, on which a computer program 904 may be stored. The processor 901 executes the computer program 904, so that the communication apparatus 900 executes the methods described in the above method embodiments. Optionally, data may also be stored in the memory 902. The communication apparatus 900 and the memory 902 may be set separately or integrated together.

Optionally, the communication apparatus 900 may further include a transceiver 905 and an antenna 906. The transceiver 905 may be called a transceiver unit, a transceiver machine, or a transceiver circuit, etc., and is used to implement a transceiver function. The transceiver 905 may include a receiver and a transmitter. The receiver may be called a receiving machine or a receiving circuit for realizing a receiving function. The transmitter may be called a transmitting machine or a sending circuit for realizing a sending function.

Optionally, the communication apparatus 900 may also include one or interface circuits 907. The interface circuit 907 is used to receive code instructions and transmit them to the processor 901. The processor 901 executes the code instructions to enable the communication apparatus 900 to execute the methods described in the foregoing method embodiments.

The transceiver 905 in the communication device 900 can be used to perform the transceiving steps in the above figures, and the processor 901 can be used to perform the processing steps in the above figures.

In an implementation, the processor 901 can include a transceiver for implementing receiving and sending functions. For example, the transceiver may be a transceiver circuit, or an interface, or an interface circuit. The transceiver circuit, the interface or the interface circuit for realizing receiving and sending functions may be separated or integrated together. The above-mentioned transceiver circuit, interface or interface circuit may be used for reading and writing code/data, or the above-mentioned transceiver circuit, interface or interface circuit may be used for signal transmission or transfer.

In an implementation, the processor 901 may store the computer program 903 which, when runs on the processor 901, causes the communication apparatus 900 to perform the methods described in the above method embodiments. The computer program 903 may be fixed in the processor 901, in which case the processor 901 may be implemented by hardware.

In an implementation, the communication apparatus 900 may include a circuit, and the circuit may implement the function of sending or receiving or communicating in the foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), a gallium arsenide (GaAs), etc.

The communication apparatus described in the above embodiments may be a network device or a terminal device, but the scope of the communication apparatus described in the present disclosure is not limited thereto, and the structure of the communication apparatus may not be limited by that shown in FIG. 9. The communication apparatus may be a stand-alone device or may be part of a relatively large device. For example, the communication apparatus may be:
(1) a stand-alone integrated circuit (IC), or a chip, or a chip system or a subsystem;
(2) a set with one or more ICs, optionally, the set of ICs may also include a storage component for storing data and the computer program;
(3) ASIC, such as a Modem;
(4) a module that can be embedded in another device;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others and so on.

For the case where the communication apparatus may be a chip or a chip system, the schematic structural diagram of the chip shown in FIG. 10 may be referred to. The chip 1000 shown in FIG. 10 includes a processor 1001 and an interface 1002. The number of processors 1001 may be one or more, and the number of interfaces 1002 may be more than one.

For the case where the chip is used to realize the function of the eRedCap terminal device in the embodiments of the present disclosure:
the interface 1002 is used to receive code instructions and transmit the code instructions to the processor;

the processor 1001 is used to run the code instructions to perform the methods shown in FIGS. 2 to 4.

For the case where the chip is used to realize the function of the network device in the embodiments of the present disclosure:
the interface 1002 is used to receive code instructions and transmit the code instructions to the processor;
the processor 1001 is used to run the code instructions to perform the methods shown in FIGS. 5 to 7.

Optionally, the chip also includes a memory 1003, which is used to store necessary computer programs and data.

Those skilled in the art can also understand that various illustrative logical blocks and steps listed in the embodiments of the present disclosure can be implemented by an electronic hardware, computer software, or a combination of both. Whether such functions are implemented by hardware or software depends on the specific application and the design requirements of the overall system. Those skilled in the art may use various methods to implement the described functions for each specific application, but such implementation should not be understood as going beyond the protection scope of the embodiments of the present disclosure.

The present disclosure also provides a readable storage medium on which instructions are stored, and when the instructions are executed by a computer, the functions of any one of the above method embodiments are realized.

The present disclosure also provides a computer program product which, when executed by a computer, implements the functions of any one of the above method embodiments.

In the above embodiments, all or part of them may be implemented by software, hardware, firmware or any combination thereof. When implemented using software, it may be implemented in whole or in part in the form of a computer program product. The computer program product includes one or more computer programs. When the computer program is loaded and executed on a computer, all or part of the processes or functions according to the embodiments of the present disclosure are generated. The computer can be a general-purpose computer, a special-purpose computer, a computer network, or other programmable apparatuses. The computer program can be stored in the computer readable storage medium or transmitted from one computer readable storage medium to another computer readable storage medium, for example, the computer program can be transmitted from one website site, computer, server or data center to another website site, computer, server or data center by wired (for example, a coaxial cable, an optical fiber, a digital subscriber line (DSL)) or wireless (for example, infrared, wireless, microwave, etc.) manner. The computer readable storage medium may be any available medium that can be accessed by a computer, or a data storage device such as a server or a data center integrated with one or more available media. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art can understand that the first, second, and other numbers involved in the present disclosure are only for convenience of description, and are not used to limit the scope of the embodiments of the present disclosure, and also indicate the sequence.

At least one in the present disclosure can also be described as one or more, and a plurality of can be two, three, four or more, which is not limited in the present disclosure. In the embodiments of the present disclosure, for a technical feature, the technical features are distinguished by “first”, “second”, “third”, “A”, “B”, “C” and “D”, etc. The technical features described by the “first”, “second”, “third”, “A”, “B”, “C” and “D” have no sequence or order of magnitude therebetween.

The corresponding relationships shown in the tables in the present disclosure can be configured or predefined. The values of the information in each table are just examples, and may be configured as other values, which are not limited in the present disclosure. When configuring the corresponding relationship between the information and each parameter, it is not necessarily required to configure all the corresponding relationships shown in the tables. For example, in the table in the present disclosure, the corresponding relationship shown in some rows may not be configured. For another example, appropriate deformation adjustments can be made based on the above tables, for example, splitting, merging, and so on. The names of parameters shown in titles in the above tables may also adopt other names understandable by the communication apparatus, and the values or representations of the parameters may also be other values or representations understandable by the communication apparatus. When the above tables are implemented, other data structures can also be used, for example, arrays, queues, containers, stacks, linear tables, pointers, linked lists, trees, graphs, structures, classes, heaps, hashtables or hash tables.

The term “predefinition” in the present disclosure may be understood as definition, definition in advance, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

It should be understood that various forms of flows shown above can be used to reorder, add, or delete steps. For example, the steps described in the embodiments of the present disclosure can be executed in parallel, sequentially, or in different orders, as long as they can achieve the desired result of technical solution in the present disclosure, which is not limited in the present disclosure.

The above specific implementations do not constitute limitations on the scope of protection of the present disclosure. Those skilled in the art should understand that various modifications, combinations, sub combinations, and substitutions can be made based on design requirements and other factors. Any modifications, equivalent substitutions, and improvements made within the spirit and principles of the present disclosure shall be included within the scope of protection of the present disclosure.

1. A method for determining a frequency domain resource, performed by an evolved reduced capability (eRedCap) terminal, the method comprising:
determining a mapping rule of virtual resource block (VRB)-to-physical resource block (PRB) supported by a physical downlink shared channel (PDSCH), wherein the mapping rule comprises that interleaved mapping is not supported, or the mapping rule is a first interleaved mapping rule; and
determining a physical frequency domain resource occupied by the PDSCH according to the mapping rule supported by the PDSCH and VRBs.

2. The method according to claim 1, wherein determining the mapping rule of VRB-to-PRB supported by the PDSCH comprises:
determining the mapping rule of VRB-to-PRB supported by the PDSCH according to a type of the PDSCH.

3. The method according to claim 2, wherein determining the mapping rule of VRB-to-PRB supported by the PDSCH according to the type of the PDSCH comprises:
determining that the mapping rule of VRB-to-PRB supported by the PDSCH is that the interleaved mapping is not supported, wherein the PDSCH is any one of following types of the PDSCH: a PDSCH carrying a system information block (SIB) 1, a PDSCH carrying other system information (OSI), a PDSCH carrying a random access message, or a PDSCH carrying a paging message; or
determining that the mapping rule of VRB-to-PRB supported by the PDSCH is the first interleaved mapping rule, wherein the PDSCH is any one of following types of the PDSCH: a unicast PDSCH, a PDSCH carrying a random access message, or a PDSCH carrying a paging message.

4. The method according to claim 1, wherein determining the mapping rule of VRB-to-PRB supported by the PDSCH comprises:
determining that the PDSCH does not support an interleaved mapping rule of VRB-to-PRB according to a protocol; or
determining that the PDSCH does not support the interleaved mapping according to a value of a specified information field in downlink control information (DCI); or
determining that the mapping rule supported by the PDSCH is the first interleaved mapping rule according to a protocol; or
determining that the mapping rule supported by the PDSCH is the first interleaved mapping rule according to indication information sent by a network device.

5. The method according to claim 1, wherein the first interleaved mapping rule comprises: a number of bundles comprised in a maximum available bandwidth of the PDSCH being determined according to a minimum frequency domain bandwidth value and a bundle size.

6. The method according to claim 5, further comprising:
for a PDSCH carrying a system information block (SIB) 1 and other system information (OSI), determining a minimum value of a maximum available bandwidth value of the PDSCH and a bandwidth value of a control resource set (CORESET) #0 as the minimum frequency domain bandwidth value; or
for a PDSCH carried by a common search space (CSS) and scheduled by downlink control information (DCI) with a format 0, with the CORESET #0 being configured, determining a minimum value of the maximum available bandwidth value of the PDSCH and the bandwidth value of the CORESET #0 as the minimum frequency domain bandwidth value; or
for the PDSCH carried by the CSS and scheduled by the DCI with the format 0, with the CORESET #0 being not configured, determining a minimum value of the maximum available bandwidth value of the PDSCH and a frequency domain bandwidth value of an initial downlink (DL) bandwidth part (BWP) as the minimum frequency domain bandwidth value; or
for a unicast PDSCH, determining a minimum value of the maximum available bandwidth value of the PDSCH and a frequency domain bandwidth value of a dedicated DL BWP as the minimum frequency domain bandwidth value.

7. (canceled)

8. A method for determining a frequency domain resource, performed by a network device, the method comprising:
determining a mapping rule of virtual resource block (VRB)-to-physical resource block (PRB) supported by a physical downlink shared channel (PDSCH) of an evolved reduced capability (eRedCap) terminal device, wherein the mapping rule comprises that interleaved mapping is not supported, or the mapping rule is a first interleaved mapping rule; and
allocating the frequency domain resource to the eRedCap terminal device according to the mapping rule of VRB-to-PRB supported by the PDSCH.

9. The method according to claim 8, wherein determining the mapping rule of VRB-to-PRB supported by the PDSCH of the eRedCap terminal device comprises:
determining the mapping rule of VRB-to-PRB supported by the PDSCH according to a type of the PDSCH.

10. The method according to claim 9, wherein determining the mapping rule of VRB-to-PRB supported by the PDSCH according to the type of the PDSCH comprises:
determining that the mapping rule of VRB-to-PRB supported by the PDSCH is that the interleaved mapping is not supported, wherein the PDSCH is a PDSCH for scheduling a system information block (SIB) 1 and other system information (OSI); or
determining that the mapping rule of VRB-to-PRB supported by the PDSCH is the first interleaved mapping rule, wherein the PDSCH is any one of following types of the PDSCH: a unicast PDSCH, a PDSCH carrying a random access response (RAR), or a PDSCH carrying a fourth access message (msg4).

11. The method according to claim 8, wherein determining the mapping rule of VRB-to-PRB supported by the PDSCH of the eRedCap terminal device comprises:
determining that the PDSCH of the eRedCap terminal device does not support an interleaved mapping rule of VRB-to-PRB according to a protocol; or
determining that the mapping rule supported by the PDSCH of the eRedCap terminal is the first interleaved mapping rule according to a protocol.

12. The method according to claim 11, further comprising at least one of:
sending downlink control information (DCI) to the eRedCap terminal device, wherein a specified information field in the DCI is configured to indicate that the PDSCH does not support the interleaved mapping or supports the interleaved mapping; or
sending indication information to the eRedCap terminal device, wherein the indication information is configured to indicate to the eRedCap terminal device that the interleaved mapping rule supported by the PDSCH is the first interleaved mapping rule.

13. The method according to claim 8, wherein the first interleaved mapping rule comprises: a number of bundles comprised in a maximum available bandwidth of the PDSCH being determined according to a minimum frequency domain bandwidth value and a bundle size.

14. The method according to claim 13, further comprising:
for a PDSCH carrying a system information block (SIB) 1 and other system information (OSI), determining a minimum value of a maximum available bandwidth value of the PDSCH and a bandwidth value of a control resource set (CORESET) #0 as the minimum frequency domain bandwidth value; or
for a PDSCH carried by a common search space (CSS) and scheduled by downlink control information (DCI) with a format 0, with the CORESET #0 being configured, determining a minimum value of the maximum available bandwidth value of the PDSCH and the bandwidth value of the CORESET #0 as the minimum frequency domain bandwidth value; or
for the PDSCH carried by the CSS and scheduled by the DCI with the format 0, with the CORESET #0 being not configured, determining a minimum value of the maximum available bandwidth value of the PDSCH and a frequency domain bandwidth value of an initial downlink (DL) bandwidth part (BWP) as the minimum frequency domain bandwidth value; or
for a unicast PDSCH, determining a minimum value of the maximum available bandwidth value of the PDSCH and a frequency domain bandwidth value of a dedicated DL BWP as the minimum frequency domain bandwidth value.

15.-17. (canceled)

18. A communication apparatus, comprising: one or more processors and a memory, wherein the memory is configured to store a computer program, and the one or more processors are configured to execute the computer program stored in the memory to cause the communication apparatus to perform the operations comprising:
determining a mapping rule of virtual resource block (VRB)-to-physical resource block (PRB) supported by a physical downlink shared channel (PDSCH), wherein the mapping rule comprises that interleaved mapping is not supported, or the mapping rule is a first interleaved mapping rule; and
determining a physical frequency domain resource occupied by the PDSCH according to the mapping rule supported by the PDSCH and VRBs.

19.-21. (canceled)

22. A communication apparatus, comprising: one or more processors and a memory, wherein the memory is configured to store a computer program, and the one or more processors are configured to execute the computer program stored in the memory to cause the communication apparatus to perform the method according to claim 8.

23. A communication apparatus, comprising: one or more processors and an interface circuit;
wherein the interface circuit is configured to receive code instructions and transmit the code instructions to the one or more processors; and
the one or more processors are configured to run the code instructions to perform the method according to claim 1.

24. A communication apparatus, comprising: one or more processors and an interface circuit;
wherein the interface circuit is configured to receive code instructions and transmit the code instructions to the one or more processors; and
the one or more processors are configured to run the code instructions to perform the method according to claim 8.

25. A communication system, comprising an evolved reduced capability (eRedCap) terminal device and a network device, wherein the eRedCap terminal device is configured to perform the method according to claim 1, and the network device is configured to perform the method according to claim 8.

26. A non-transitory computer-readable storage medium for storing instructions that, when executed by a processor, cause the processor to perform the method according to claim 1.

27. A non-transitory computer-readable storage medium for storing instructions that, when executed by a processor, cause the processor to perform the method according to claim 8.
